(19) United States
(12) Patent Application Publication
(10) Pub. No.: US 2024/0043303 A1
(43) Pub. Date: Feb. 8, 2024

(54) Method and system for treating metals dissolved in a solution

(71) Applicants: Gérard GASSER, WITTENHEIM (FR); AFIG'EO, SIERENTZ (FR)

(72) Inventors: Dominique BUZARÉ, SCHLIERBACH (FR); Gerard GASSER, WITTENHEIM (FR)

(21) Appl. No.: 18/266,266

(22) PCT Filed: Dec. 7, 2021
(86) PCT No.: PCT/EP2021/084620

§ 371 Date: Jun. 8, 2023

(30) Foreign Application Priority Data
Dec. 9, 2020 (FR) FR20 12927

(51) Int. Cl. C02F 9/00

(52) U.S. Cl. CPC C02F 9/00; C02F 1/70

(57) ABSTRACT

A process is provided for treating at least one metal in solution in an effluent that includes a step of adding and mixing a mineral or organic reducing composition into the solution comprising the metal, followed by a step of activating the reduction of the metal and neutralizing the effluent by controlled addition of a neutralization solution-based composition. The method also includes a step of precipitating the metal, and a step of recovering the precipitated metal and separating the precipitated metal from the neutralized effluent by filtration of the reduction reaction mixture.

The present invention relates to the field of systems for treating metals dissolved in a solvent and more particularly to systems for treating metals that make it possible to produce a solvent that is sufficiently uncontaminated that it can be released into the environment.

The implementation of processes on an industrial scale is responsible for the generation of a significant output of effluents comprising various metals in solution in more or less elevated proportions. The release of such effluents directly into the environment is generally strictly prohibited. Consequently, industrial units are obligated to treat these effluents or at least store them as waste for subsequent treatment by a specialized service provider. Indeed, the treatment processes currently implemented, whether they be treatment by electrocoagulation, by absorption involving ion exchange resins or else by a basic compound, generally result in the production of metal hydroxides which, although not released into the sewer, must nevertheless be subject to controlled storage in landfills.

An alternative to this solution producing metal hydroxides consists in implementing treatments based on electrodialysis performed on ion exchange membranes placed in an electric field or, alternatively, on electrodiaresis involving an absorption of anions and cations by electrodialysis on an ion exchange resin regenerated by an electrostatic field. However, the application of such treatment processes relies on systems that are often complex and require high investments that industries with low added value are generally unable to support.

The aim of the present invention is to overcome these drawbacks by proposing a technical solution for treating effluents comprising various metals in solution that makes it possible to obtain a liquid product which fully satisfies the ecological constraints for being released into the environment and yet is both easy and economical in implementation.

The invention relates to a process for treating at least one metal in solution in an effluent, characterized in that the process comprises:
a step of adding and mixing a mineral or organic reducing composition into the solution comprising the metal, followed by
a step of activating the reduction of the metal and neutralizing the effluent by controlled addition of a neutralization solution-based composition,
a step of precipitating the metal,
a step of recovering the precipitated metal and separating the precipitated metal from the neutralized effluent by filtration of the reduction reaction mixture.

The invention also relates to a system for implementing a process according to the invention, characterized in that the system comprises at least:
a tank for preparing the mixture of the metal in solution in an effluent with a reducing composition,
a reaction chamber comprising at least, at a first end:
   an orifice for injecting a mixture comprising, firstly, a solution of at least one metal in solution in an effluent and, secondly, a reducing composition,
   an injection orifice for a neutralization solution-based composition, and, at a second end, an orifice for discharging the reaction products,
a device for separating the precipitated reaction products from the products mixed in liquid form.

The invention will be better understood by virtue of the following description relating to preferred embodiments which are given by way of non-limiting examples and are explained with reference to the appended schematic drawings, in which:

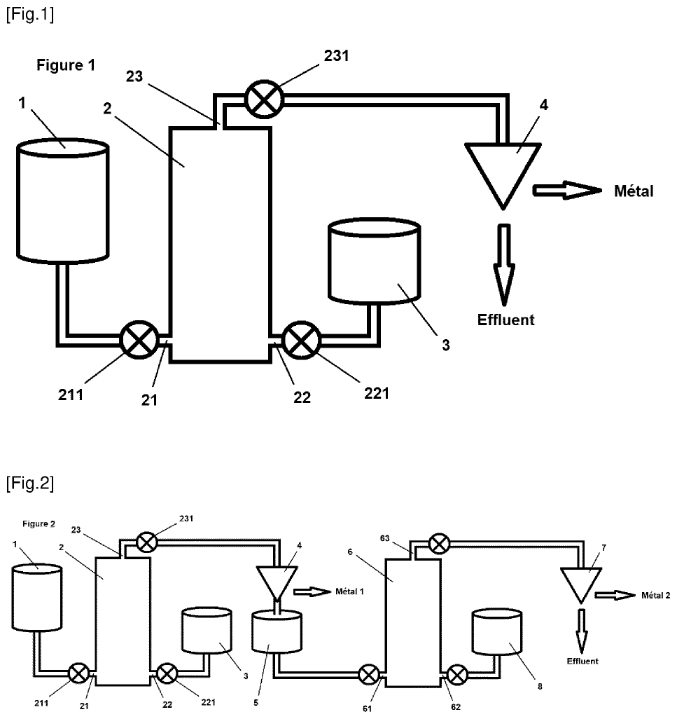

FIG. 1. is a schematic representation of a first example of a system for implementing a treatment process according to the invention.

FIG. 2. is a schematic representation of a second example of a system for implementing a treatment process according to the invention.

The invention relates to a process for treating at least one metal in solution in an effluent, characterized in that the process comprises:
a step of adding and mixing a mineral or organic reducing composition into the solution comprising the metal, followed by
a step of activating the reduction of the metal and neutralizing the effluent by controlled addition of a neutralization solution-based composition,
a step of precipitating the metal,
a step of recovering the precipitated metal and separating the precipitated metal from the neutralized effluent by filtration of the reduction reaction mixture.

The process of the invention is based on a reduction of the metal ions in solution in the effluent by reaction with a reducing composition. This process is able to be implemented for any type of metal, whether this be a noble or seminoble metal such as platinum Pt, gold Au, copper Cu, silver Ag or a transition metal such as nickel Ni, cobalt Co or zinc Zn.

Initially, the reducing composition effects a reduction of the metal in solution in the effluent, then the effluent in which the reduced metal is dissolved is neutralized by a controlled addition based on neutralization solution. However, it should be noted that within the context of the mixture of the various elements, these reactions are performed simultaneously, in particular when the performance of one which is exothermic facilitates the performance of the other of which at least the activation is endothermic. The neutralization solution is of the basic type, such as a sodium hydroxide-based composition within the context of a neutralization of an acidic effluent which would contain the dissolved metal. Alternatively, this neutralization solution is of the acidic type within the context of a neutralization of a basic effluent which would contain the dissolved metal.

According to one particular example corresponding to an embodiment variant of the treatment process according to the invention, this reducing composition is selected depending on at least two parameters including in particular, firstly, the value of the redox potential of the reducing composition and, secondly, the metal in solution that is intended to be precipitated. Within the context of noble metals known for their resistance to corrosion and oxidation, such as platinum Pt, gold Au, silver Ag, rhodium Rh, osmium Os, palladium Pd, ruthenium Ru, iridium Ir, but also for metals pertaining to a broader definition of noble metals such as copper Cu, rhenium Re and mercury Hg, the reducing composition will preferentially be selected from sugars of the monosaccharide type, which are carbohydrate monomers. Within the context of metals having a greater electropositivity, namely metals with more negative redox potentials, the reducing composition will preferentially comprise a more highly reducing compound of the hydroxytyrosol type or an analog of the tyrosol family. A reducing composition blending several of the various compounds listed can also be envisaged.

It should be noted that, within the context of the implemented process, the step of reducing the metal involves a reducing agent that is sufficiently strong to achieve reduction of the metal to a crystalline metallic state, so that the metal is precipitated in the form of this crystalline metallic state. Thus, the step of reducing the metal is a redox reaction during which the metal ions in solution in the effluent change valences, such that these pass from a positive value (+n) to a zero value (0). The metals present in an effluent are thus separated, allowing them to be recovered in a pure state.

According to one particular example corresponding to another embodiment variant of the process according to the invention, which is capable of being combined with the variant detailed above, the reducing composition is selected so that the products of the reduction reaction, other than the precipitated metal, are biodegradable. This capability is found in particular among the various composition examples proposed above as an embodiment variant of the process of the invention.

According to one particular example corresponding to another embodiment variant of the treatment process according to the invention, which is capable of being combined with the variants detailed above, the reducing composition comprises at least glucose. This glucose forms a readily available and inexpensive reducing agent for implementing a redox reaction as in the context of the invention. Furthermore, according to an example corresponding to a preferred embodiment variant of the invention, the glucose is provided by an acid hydrolysis of dextrin present among the various elements of the reducing composition used within the context of the invention. However, according to an embodiment alternative, it should be noted that glucose and dextrin could be replaced by polysaccharides and/or compounds of the hydroxytyrosol type or an analog of the same family.

According to one particular example corresponding to another embodiment variant of the process according to the invention, which is capable of being combined with the variants detailed above, the step of activating the redox reaction takes place spontaneously when the metal in solution in the effluent is mixed with the reducing composition. This scenario is likely to be encountered within the context of a reaction involving copper Cu in a medium blending hydrochloric acid and dextrin with caustic soda. Similarly, this case is also likely to be encountered within the context of a reaction involving nickel Ni in a fluoroborate medium in the form of nickel fluoroborate NiBF₄ in a mixture of fluoroboric acid H₂BF₄ and dextrin with sodium hydroxide.

According to one particular example corresponding to another embodiment variant of the treatment process according to the invention, which constitutes an alternative to the variant detailed above, the step of activating the reduction of the metal also comprises a step of heating the mixture comprising the reducing composition and the solution comprising the metal in the effluent. Although this heating step is capable of being effected constantly throughout the reduction reaction of the metal, it is conceivable, when the system for implementing the process allows it, to perform this heating step only at the time of activation of the reduction reaction of the metal so that this reaction is self-sustained by supply of an additional reactant to the mixture treated within the context of the process.

According to one particular example corresponding to another embodiment variant of the treatment process according to the invention, which is capable of being combined with the variants detailed above, the amount of energy released during the step of neutralizing the eluent by the neutralization solution-based composition is at least greater than half the amount of energy needed to activate and/or sustain the reduction reaction of the metal. Thus, when the neutralization reaction of the effluent is exothermic, the heat provided by this reaction contributes to the continuation and sustaining of the reduction reaction of the metal in solution in the effluent. According to a preferred exemplary embodiment of the process, this amount of energy released is of the order of 80% of the amount of energy needed for the activation and/or sustaining of the reduction reaction of the metal, so that the implementation of the process according to the invention requires a reduced input of energy.

According to one particular example corresponding to a specific embodiment variant of the treatment process according to the invention, the process is performed when:
the pH is between 7 and 13, preferentially between 8 and 12 and ideally between 9 and 11,
the reaction temperature is between 60° C. and 120° C., preferentially between 70° C. and 110° C. and ideally between 80° C. and 100° C.,
the redox potential is between −1100 and −500 mV, preferentially between −1000 mV and −600 mV and ideally between −900 mV and −700 mV.

The invention also relates to a system for implementing a treatment process according to the invention, characterized in that the system comprises at least:
a tank 1 for preparing the mixture of the metal in solution in an effluent with a reducing composition,
a tank 3 for a neutralization solution-based composition,
a reaction chamber 2 comprising at least, at a first end:
   an orifice 21 for injecting a mixture comprising, firstly, a solution of at least one metal in solution in an effluent and, secondly, a reducing composition, the mixture being obtained from the preparation tank 1,
   an orifice 22 for injecting a neutralization solution-based composition obtained from a dedicated tank 3, and, at a second end, an orifice 23 for discharging the reaction products,
a separation device 4 connected to the discharge orifice 23 of the reaction chamber 2 so as to filter the precipitated reaction products from the products mixed in liquid form.

In such a system, the preparation tank 1 is configured to receive a mixture of the metal in solution in an effluent with a reducing composition. According to an exemplary construction pertaining to a preferred embodiment variant of the system, the tank 1 is associated with a mixing device which makes it possible to homogenize the distribution of the compounds in solution so as to optimize the reduction reaction of the metal ions with the reducing agents of the mixture. According to another exemplary construction pertaining to a preferred construction variant of the system and capable of being combined with the preceding variants, the tank 1 is associated with a mechanism for heating the mixture. Such a heating mechanism is thus capable of providing sufficient heat to initiate the reduction reaction of the metal ions in solution by the reducing composition when this reaction is endothermic.

The system also incorporates at least one reaction chamber 2 within which most of the reactions of the treatment are carried out, namely, firstly, the neutralization of the effluent by a neutralization solution-based composition and, secondly, the reduction of the metal ions in order to achieve the precipitation thereof. The reaction chamber 2 is thus fed at specific injection orifices 21, 22, firstly, with a mixture of the reducing composition and the metal to be treated in solution with its effluent originating from the reaction chamber 2 and, secondly, with neutralization solution-based composition originating from the dedicated tank. The reaction products are withdrawn from the chamber 2 at a dedicated discharge orifice 23 in order to be directed towards a separation device 4.

According to one particular example corresponding to a construction variant of the system according to the invention, firstly, the discharge orifice 23 and, secondly, the injection orifices 21, 22 are located at opposite ends of the reaction chamber 2 so as to impose a unidirectional movement of the compounds in reaction within the chamber 2. Thus, the compounds enter, in the form of reactants, the reaction chamber 2 at the injection orifices 21, 22 positioned at a first end of the chamber 2. Under the effect of the continuous reactant injection flow at the orifices 21, 22, the compounds are moved through the chamber 2 conjointly with the reactions thereof so that, at the discharge orifice 24, the compounds are transformed so as to correspond to the products of the reactions involved within the context of the process of the invention. The reactions of the compounds are carried out progressively as they move within the chamber 2.

Thus, the reactions of the compounds which correspond to the treatment process of the invention are carried out conjointly with the progressive movement thereof within the reaction chamber 2. Preferentially, the reaction chamber 2 has a substantially elongate configuration, for example a cylindrical configuration. Such a configuration has the advantage of being able to easily impose a direction of movement of the flow of the mixture within the reaction chamber 2 while being maximally freed from any parasitic turbulence.

According to one particular exemplary construction corresponding to a construction variant of the system according to the invention, this reaction chamber 2 is arranged in a substantially vertical arrangement so that, firstly, the injection orifices 21, 22 are positioned at the lower end of the chamber 2 and that, secondly, the discharge orifice 23 is positioned at the end of the upper part. Such an arrangement makes it possible to discharge the reaction products by simple overflow. The flow of the mixture within the reaction chamber 2 then takes place from bottom to top and is held by gravity within the chamber 2. Also, in such an arrangement, the speed of movement of the flow of the mixture is capable of being controlled simply by controlling the injection of the various reactants at the two injection nozzles 21, 22, namely, firstly, the mixture of a reducing composition with the metal in solution in its effluent and, secondly, a neutralization solution-based composition. According to an alternative arrangement, the injection orifices 21, 22 are positioned at the upper end of the chamber 2 while the discharge orifice 23 is positioned at the end of the lower part. Under these conditions, the speed of movement of the flow of the mixture is capable of being controlled by controlling the discharge of the reaction products at the discharge orifice 23 of the reaction chamber 2. It should however be taken into account that the flow at the discharge from the reaction chamber 2 must be in proportion with the flows at the injection orifices 21, 22 so as to avoid an overpressure within the reaction chamber 2.

According to one particular example corresponding to a construction variant of the system according to the invention, each of the injection orifices 21, 22 is associated with a respective injection mechanism 211, 221. Each of these different injection mechanisms 211, 221 is able to take the form of a pump or alternatively a valve simply controlling the opening and closing of the flow. When the injection mechanism 211, 221 is realized in the form of a valve, the pressure within each of the tanks 1, 3 of liquid reactants should be greater than that within the reaction chamber 2.

According to a specific example corresponding to the abovementioned particular construction variant of the system according to the invention, each of the injection mechanisms 211, 221 is associated with an injection flow control device parameterized at least as a function, firstly, of the volume of the reaction chamber 2 and, secondly, of the rate of the reactions of reduction of the metal and of neutralization of the effluent by the neutralization solution-based composition. Thus, by controlling the speed of the flow of the compounds moving through the reaction chamber 2, the system of the invention controls the reactions within the chamber so that these reactions are complete when the compounds moved to the discharge orifice 23 exit the reaction chamber 2 in the form of products.

According to another specific example corresponding to the abovementioned particular construction variants of the system according to the invention, the reaction chamber 2 is associated with at least one temperature measurement sensor and/or at least one pH measurement sensor and/at least one redox potential measurement sensor. These various sensors integrated within the reaction chamber 2 make it possible to monitor the progress of each of the various reactions carried out by the reactants present, and possibly to detect any problem therein.

According to another specific example corresponding to a variant which is capable of being combined with the abovementioned particular construction variants, each of the injection mechanisms 211, 221 is associated with a control interface connected to at least one temperature measurement sensor and/or at least one pH measurement sensor and/at least one redox potential measurement sensor. Thus, the control interface is able to manage the flow of each of the compounds in reaction chamber 2 directly on the basis of the measured values of the progress of one or other of the reactions present.

According to a construction alternative, when the speed of movement of the flow of the mixture in the reaction chamber 2 is capable of being controlled by managing the discharge of the reaction products at the discharge orifice 23, this discharge orifice 23 is also associated with a discharge mechanism 231. This discharge mechanism 231 is also capable of being commanded or controlled as a function of one or more of the measured values of the progress of the reactions produced by sensors integrated within the reaction chamber 2.

According to an example corresponding to another construction variant of the system according to the invention and capable of being combined with the other variants detailed above, the reaction chamber 2 is constructed so as to be surrounded by a thermally insulating layer. The reaction chamber 2 thus produced is adiabatic and makes it possible to optimize the energy transfers between the various reactions present which are, firstly, the neutralization of the effluent and, secondly, the reduction of the metal ions. This thermal insulation thus ensures a limitation of the energy losses in the reaction chamber 2 and makes it possible to achieve a self-sustained activation of the reduction of the metal ions by the reducing composition within the chamber 2.

According to an example corresponding to another construction variant of the system according to the invention and capable of being an alternative to the variant detailed above, the reaction chamber 2 is constructed so as to be associated with a heating mechanism. This heating mechanism is then capable of supplying energy to the reactants within the reaction chamber 2 so as to allow activation of the endothermic reactions, or even to force all of the reactions. According to one particular variant of this exemplary construction, this heating mechanism is associated with a control interface connected to at least one temperature measurement sensor and/or at least one pH measurement sensor and/at least one redox potential measurement sensor. Thus, the actuation of the heating mechanism is capable of being initiated as a function of one or more of the measured values of the progress of the reactions produced by sensors integrated within the reaction chamber 2.

According to an example corresponding to another construction variant of the system according to the invention and capable of being combined with the other variants detailed above, the separation device 4 positioned at the outlet of the reaction chamber 2, at the discharge orifice 23, is realized by a filtration mechanism configured to recover the reduced metal from the rest of the solution. Such a separation device can take the form of simple bag filters, for example of the “big bag” type, or else the form of cartridge filters or filter presses, etc.

According to an example corresponding to another construction variant of the system according to the invention and capable of being combined with the other variants detailed above, the system comprises:
an additional tank 5 for preparing the mixture of a second reducing composition with the liquid solution resulting from the implementation of the process, the second reducing composition being suitable for a second metal in solution,
a second reaction chamber 6 comprising at least, at a first end:
   an injection orifice 61 for the mixture obtained from the additional tank 5,
   an injection orifice 62 for a neutralization solution-based composition, and, at a second end, an orifice 63 for discharging the reaction products,
a second device 7 for separating the precipitated reaction products from the products mixed in liquid form.

According to such a construction variant, the system according to the invention comprises in particular several reaction chambers 2, 6 and separation devices 4, 7 arranged alternately in series so as to perform, firstly, reduction reactions of one or more respective metals and, secondly, separations or recoveries of these metals from the compounds or reaction products in solution. Such a construction variant of the system according to the invention also makes it possible to perform reductions of different metals independently, that is to say in different reaction media, so as, firstly, to prevent the respective reduction reactions from interfering with each other and, secondly, to allow each of the reduction reactions to be carried out despite their possible respective implementation incompatibilities. The various exemplary embodiment variants detailed above for each of the different elements of the first assembly combining the tanks 1, 3, the first reaction chamber 2 and the first separation device 4 are also capable of being applied to each of the elements of the additional assembly of the system which combines one or more tanks, an additional reaction chamber 6 and a new separation device 7. Similarly, this second assembly can comprise a specific tank 8 for feeding the additional reaction chamber 6 at a dedicated injection orifice with a neutralization solution. The concentration and the composition of the neutralization solution contained in this second tank 8 can differ from that of the first neutralization solution tank 3 and be specific to the reaction desired within the additional reaction chamber 6.

Of course, the invention is not limited to the embodiments described and shown in the appended drawings. Modifications remain possible, in particular in terms of the makeup of the various elements or by substitution of equivalent techniques, without otherwise departing from the scope of protection of the invention.

1. A process for treating at least one metal in solution in an effluent, wherein the process comprises:
a step of adding and mixing a mineral or organic reducing composition into the solution comprising the metal, followed by
a step of activating the reduction of the metal and neutralizing the effluent by controlled addition of a composition based on a neutralization solution,
a step of precipitating the metal, and
a step of recovering the precipitated metal and separating the precipitated metal from the neutralized effluent by filtration of the reduction reaction mixture.

2. The treatment process as claimed in claim 1, wherein the step of activating the reduction of the metal also comprises a step of heating the mixture comprising the reducing composition and the solution comprising the metal in the effluent.

3. The treatment process as claimed in claim 1, wherein the reducing composition is selected so that the products of the reduction reaction, other than the precipitated metal, are biodegradable.

4. The treatment process as claimed in claim 1, the reducing composition comprises at least glucose.

5. The treatment process as claimed in claim 1, wherein the amount of energy released during the step of neutralizing the eluent by the neutralization solution-based composition is at least greater than half the amount of energy needed to activate and/or sustain the reduction reaction of the metal.

6. The treatment process as claimed in claim 1, wherein the process comprises a prior step of selecting the reducing composition depending on at least two parameters including in particular, firstly, the value of the redox potential of the reducing composition and, secondly, the metal in solution that is intended to be precipitated.

7. A system for implementing a treatment process as claimed in claim 1, wherein the system comprises at least:
a tank for preparing the mixture of the metal in solution in an effluent with a reducing composition,
a tank for a neutralization solution-based composition,
a reaction chamber comprising at least, at a first end:
an orifice for injecting a mixture comprising, firstly, a solution of at least one metal in solution in an effluent and, secondly, a reducing composition, the mixture being obtained from the preparation tank,
an orifice for injecting a neutralization solution-based composition obtained from a dedicated tank,
and, at a second end, an orifice for discharging the reaction products,
a separation device connected to the discharge orifice of the reaction chamber so as to filter the precipitated reaction products from the products mixed in liquid form.

8. The system as claimed in claim 7, wherein the reaction chamber is associated with at least one temperature measurement sensor and/or at least one pH measurement sensor and/at least one redox potential measurement sensor.

9. The system as claimed in claim 7, wherein the tank is associated with a mechanism for heating the mixture.

10. The system as claimed in claim 7, wherein each of the injection orifices is associated with a respective injection respective injection mechanism.

11. The system as claimed in claim 10, wherein each of the injection mechanisms is associated with an injection flow control device parameterized at least as a function, firstly, of the volume of the reaction chamber and, secondly, of the rate of the reactions of reduction of the metal and of neutralization of the effluent by the neutralization solution-based composition.

12. The system as claimed in claim 10, wherein each of the injection mechanisms is associated with a control interface connected to at least one temperature measurement sensor and/or at least one pH measurement sensor and/at least one redox potential measurement sensor.

13. The system as claimed in claim 7, wherein the reaction chamber is arranged in a substantially vertical arrangement so that, firstly, the injection orifices are positioned at the lower end of the chamber and that, secondly, the discharge orifice is positioned at the end of the upper part.

14. The system as claimed in claim 7, wherein the system comprises:
an additional tank for preparing the mixture of a second reducing composition with the liquid solution resulting from the implementation of the process, the second reducing composition being suitable for a second metal in solution,
a second reaction chamber comprising at least, at a first end:
an injection orifice for the mixture obtained from the additional tank,
an injection orifice for a neutralization solution-based composition, and, at a second end, an orifice for discharging the reaction products,
a second device for separating the precipitated reaction products from the products mixed in liquid form.
